(19) United States
(12) Patent Application Publication
(10) Pub. No.: US 2007/0160728 A1
(43) Pub. Date: Jul. 12, 2007

(54) Gluten-free food products including deflavored bean powder

(76) Inventors: Noel Rudie, Oskaloosa, IA (US); Brent Sorenson, Fertile, MN (US); James Paul LeCureux, Ubly, MI (US); Brian Keith Sorenson, Fisher, MN (US)

Correspondence Address: MERCHANT & GOULD PC, P.O. BOX 2903, MINNEAPOLIS, MN, 55402-0903, US

(21) Appl. No.: 11/580,705

(22) Filed: Oct. 13, 2006

Related U.S. Application Data
(60) Provisional application No. 60/727,194, filed on Oct. 14, 2005.
(60) Provisional application No. 60/727,283, filed on Oct. 13, 2005.

(51) Int. Cl. A23L 1/00

(52) U.S. Cl. 426/510

(57) ABSTRACT

The present invention relates to gluten free or reduced-gluten food products including deflavored vegetable powder. The food products of the invention can have improved taste, texture, or nutritional value compared to conventional gluten-free food products

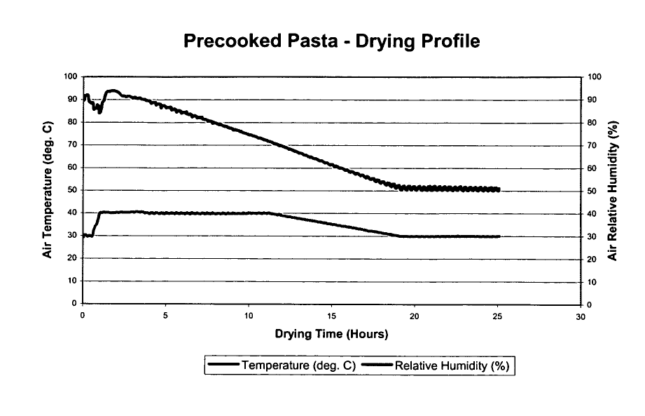

### CROSS-REFERENCE TO RELATED APPLICATIONS

This application claims benefit of Provisional Application Nos. 60/727,283, filed Oct. 13, 2005, and 60/727,194, filed Oct. 14, 2005, the disclosures of which are incorporated herein by reference.

### FIELD OF THE INVENTION

The present invention relates to gluten free or reduced-gluten food products including deflavored vegetable powder. The food products of the invention can have improved taste, texture, or nutritional value compared to conventional gluten-free food products.

### BACKGROUND OF THE INVENTION

Gluten-free food products often suffer from either diminished nutritional value and/or flavor compared to the corresponding gluten-containing food product. There remains a need for gluten-free food products including increased levels of protein and reduced presence of off odor or taste.

### SUMMARY OF THE INVENTION

The present invention relates to gluten free or reduced-gluten food products including deflavored vegetable powder. The food products of the invention can have improved taste, texture, or nutritional value compared to conventional gluten-free food products.

The deflavored vegetable powder of the invention can be a deflavored bean powder, such as deflavored pinto bean or navy bean powder. The deflavored vegetable powder used to produce food products of the invention may have reduced lipoxygenase activity relative to raw vegetable powder. The food product of the invention can be a baked good, for example, a cereal, a pasta, a bread, a muffin, or a cookie.

The present invention includes a food product comprising deflavored bean powder. The product can contain an effective amount of deflavored bean powder. The product can contain about 5 wt-% to about 60 wt-% of the deflavored bean powder. The food product can be a pasta that contains about 40 wt-% to about 60 wt-% of the deflavored bean powder. The pasta can contain deflavored navy bean powder. The food product can be a cereal that contains about 30 wt-% to about 50 wt-% of the deflavored bean powder. The cereal can contain deflavored pinto bean powder. The food product can be a cookie that contains about 10 wt-% to about 30 wt-% of the deflavored bean powder. The cookie can contain deflavored pinto bean powder. The food product can be a muffin that contains about 10 wt-% to about 20 wt-% of the deflavored bean powder. The muffin can contain deflavored pinto bean powder. The food product can be a bread that contains about 5 wt-% to about 20 wt-% of the deflavored bean powder. The bread can contain deflavored pinto bean powder.

The food product can contain a deflavored powdered bean powder characterized in that an aqueous homogenate of the deflavored bean powder has a flavor rank of at least about 7, indicating flavor of slightly beany flavor and little nutty flavor. This flavor rank can be based on a flavor scale on which 1 is the lowest rank and indicates green beany flavor, and 10 is the highest rank and indicates fresh and pleasant flavor. The food product can contain a deflavored powdered bean powder characterized in that an aqueous homogenate of the deflavored bean powder has an off taste rank of less than or equal to about 3, indicating off taste of slightly oxidized, slight cardboard, or somewhat green off taste. This off taste rank can be based on an off taste scale on which 1 indicates the lowest amount of off taste and no rancid taste, and 10 indicates the highest amount of off taste and maximum rancidity. The food product can contain a deflavored powdered bean powder characterized in that the deflavored bean powder possesses less than 75% of the lipoxygenase activity of the raw bean powder.

The food product can contain deflavored bean powder produced from a milled vegetable that was not exposed to a temperature above 40° C. during milling.

The food product can contain deflavored bean powder produced by a process including contacting millable vegetable with steam at about 95° C. to about 130° C. for about 3 to about 12 min. This method can also include milling the millable vegetable, milling including: contacting the vegetable with air previously passed through a cooling apparatus during milling, contacting the vegetable with air previously passed through a drying apparatus during milling, or contacting the vegetable during milling with air previously passed through a cooling apparatus and a drying apparatus. The method can also include, simultaneously with milling, classifying the milled vegetable, classifying including: contacting the vegetable with air previously passed through a cooling apparatus during classifying, contacting the vegetable with air from a drying apparatus during classifying, or contacting the vegetable during classifying with air previously passed through a cooling apparatus and a drying apparatus. This method can also include producing vegetable powder of which 70% has a particle size less than 20 microns.

### DETAILED DESCRIPTION OF THE INVENTION

Definitions

As used herein, “deflavored vegetable powder” or “deflavored bean powder” refers to powder having undergone a process resulting in the reduction or elimination of objectionable flavor notes characteristic of millable vegetables, including, for example, pinto beans or navy beans.

As used herein, the term “about” modifying the quantity of an ingredient in the compositions of the invention or employed in the methods of the invention refers to variation in the numerical quantity that can occur, for example, through typical processing and measuring procedures used for making and evaluating vegetable powders in the real world; through inadvertent error in these procedures; through differences in the manufacture, source, or purity of the ingredients or apparatus employed to make the powders or carry out the methods; and the like. Whether or not modified by the term “about”, the claims include equivalents to the quantities. Any range or amount described below and modified by the term “about” can also describe an embodiment of the present invention when not modified by the term “about”.

By “proofing”, is meant the time required for yeast in a dough to produce sufficient amount of carbon dioxide gas to give desired height, volume and structure in a baked product.

By “dough”, is meant a mixture of flour/starch and other ingredients firm enough to knead or roll. In addition, it also refers to the cohesive product that results from the mixture, after subsequent proofing, of flour and/or starch, water along with possibly fats and other usual ingredients normally entering the composition of a usual dough such as salt, yeast or chemical leavening agents, fibers, egg proteins, milk proteins and sugar.

By “baked product”, is meant any product prepared from a dough, either of a soft or a crisp character. Examples of baked products, whether of a white, light or dark type, which may be advantageously produced by the present invention include without limitation buns, cookies, biscuits, donuts, crackers, muffins, cakes, bread and rolls.

The Food Products

The present invention relates to gluten free or reduced-gluten food products including deflavored vegetable powder. The food products of the invention can have improved taste, texture, or nutritional value compared to conventional gluten-free food products.

In an embodiment, the present invention includes gluten-free food products such as pasta, cereal, and other baked and formulated products. According to the present invention, the food product can have one or more advantageous characteristics, such as, for example: improved nutritional value compared to conventional gluten-free product, e.g., increased fiber and/or protein levels; texture similar to the corresponding gluten-containing product, which, in certain embodiments, can be due to the protein content of the deflavored bean powder; taste profile similar to the corresponding gluten-containing product, which, in certain embodiments, can be due to the deflavored vegetable powder employed in the gluten-free product.

The present invention also relates to methods of making food product of the invention such as gluten-free products. The present method can employ a twin screw extruder for incorporating deflavored vegetable powder into a product such as a pasta or a cereal.

In an embodiment, a food product of the invention possesses advantageous characteristics due to the presence of deflavored vegetable powder. In an embodiment, a food product of the invention possesses advantageous characteristics resulting from substitution of at least a portion of the gluten content of the food product with deflavored vegetable powder. In an embodiment, the deflavored vegetable powder is deflavored bean powder. In an embodiment, the deflavored bean powder is produced from navy beans, pinto beans, or a combination of navy beans and pinto beans.

Cereal

In an embodiment, the present invention includes a gluten-free cereal with good taste, good mouth feel, and/or good color. In an embodiment and by nonlimiting example, the gluten-free cereal includes about 10 wt-% to about 60 wt-% deflavored bean powder by weight, and may include, for example, about 30 wt-% to about 60 wt-%, about 40 wt-% to about 50 wt-%, about 15 wt-%, about 25 wt-%, about 40 wt-%, about 44 wt-%, about 50 wt-%, or more than about 50 wt-% deflavored bean powder by weight. In an embodiment, the deflavored bean powder is deflavored pinto bean powder.

In an embodiment, a cereal of the invention can also include other ingredients known in the art. By way of nonlimiting example, a cereal may include in any combination any suitable amount of flour such as rice flour, sugar, salt, or flavoring ingredients such as raspberry flavoring, cinnamon, or vanilla.

In specific embodiments, a pinto bean cereal of the invention may be a base cereal, a raspberry flavored cereal, or a cinnamon cereal including the listed ingredients.

Base Cereal: about 50 wt-% deflavored pinto bean powder, about 45 wt-% (e.g., 44 wt-%) rice flour, about 5 wt-% sugar, and about 1 wt-% salt.

Raspberry Flavored Cereal: about 40 wt-% deflavored pinto bean powder, about 35 wt-% rice flour, about 15 (e.g., 14) wt-% sugar, about 1 (e.g., 0.8) wt-% salt, about 5 (e.g., 6.5) wt-% raspberry flavoring, and about 5 (e.g., 4.4) wt-% beet powder for color.

Cinnamon Cereal: about 45 (e.g., 44) wt-% deflavored pinto bean powder, about 40 (e.g., 39) wt-% rice flour, about 15 wt-% sugar, about 1 (e.g., 0.9) wt-% salt, about 0.5 wt-% cinnamon, and about 0.5 wt-% vanilla.

In specific embodiments, a gluten-free cereal or low-gluten cereal of the invention may include the following ingredients: about 50 wt-% non-GMO rice, about 50 wt-% deflavored navy bean powder, and about 0.8 (e.g., 0.75) wt-% glycerol monostearate (Dimodan).

Any suitable method known in the art may be used to produce a gluten-free cereal of the invention. In an embodiment, Wenger TX-57 or TX-85 extruders are used, with equipment settings similar to those conventionally employed in cereal manufacture. The flour mixture is blended in a ribbon blender. The flour mixture is turned into a batter with the addition of steam and water and pressed through the dies.

Bread

In an embodiment, the present invention includes a gluten-free or low gluten bread with good loaf volume, soft crumb texture, and/or good crumb color. In an embodiment, the gluten-free bread includes about 5 wt-% to about 20 wt-%, about 5 wt-% to about 10 wt-%, about 10 wt-% to about 20 wt-%, or about 15 wt-% to about 20 wt-% deflavored bean powder by weight, and may include, for example, about 12 wt-% deflavored bean powder by weight. In an embodiment, the deflavored bean powder is deflavored pinto bean powder.

In an embodiment, a gluten-free bread of the invention can also include other ingredients known in the art. By way of nonlimiting example, a gluten-free bread may include any combination of suitable amounts of water, eggs, oil such as canola oil, sugar, flour such as rice flour and/or tapioca flour, starch such as potato starch, a gum such as xanthan gum, slat, milk including nonfat dried milk, yeast, Benecel, or Blanose.

In specific embodiments, a gluten-free bread of the invention may include the following ingredients: about 35 (e.g., 34) wt-% water, about 15 wt-% eggs, about 3 (e.g., 3.4) wt-% canola oil, about 2 (e.g., 1.5) wt-% sugar, about 10 (e.g., 12) wt-% rice flour, about 10 (e.g., 12) wt-% deflavored pinto bean flour, about 10 (e.g., 9) wt-% potato starch, about 5 wt-% tapioca flour, about 1 (e.g., 0.8) wt-% xanthan gum, about 0.3 wt-% Benecel, about 0.1 wt-% Blanose, about 0.8 wt-% salt, about 5 wt-% nonfat dried milk, and about 0.6 wt-% instant yeast.

Any suitable method known in the art may be used to produce a gluten-free bread of the invention. In an embodiment, all ingredients were at room temperature (about 72° F.). Water was heated in microwave to 110-115° F. Water was placed in mixing bowl; yeast was sprinkled on top and allowed to dissolve for 5 min. Dry ingredients were sifted into the pan and dough was blended at stir speed. Eggs and oil were added and blended at stir speed. The bowl was scraped down and dough was mixed for 5 min. at medium speed. Mixing was stopped and the bowl was scraped down halfway through mixing. Dough was scraped into 2 well-greased loaf pans, with 750 g in each can. Tops were smoothed with a bread scraper and weight was checked. Dough was proofed 1 hour at 77° F., 70 wt-% RH. Bread with cellulose gums was baked 50 min. at 400° F. Bread without cellulose gums was baked 55 min. at 400° F. Bread was covered with aluminum foil after 20 min. of baking to prevent excessive browning. Bread was placed in plastic bags after 2 hours of cooling.

Muffin

In an embodiment, the present invention includes a gluten-free or low gluten muffin with good color, good texture, and/or good flavor. In an embodiment, the gluten-free muffin includes about 5 wt-% to about 60 wt-% deflavored bean powder by weight, and may include, by way of nonlimiting example, about 10 wt-% to about 20 wt-%, or about 15 wt-% deflavored bean powder by weight. In an embodiment, the deflavored bean powder is deflavored pinto bean powder.

In an embodiment, a gluten-free muffin of the invention can also include other ingredients known in the art. By way of nonlimiting example, a gluten-free muffin can include any combination of suitable amounts of deflavored flour such as deflavored pinto bean flour, starch such as corn starch, sugar, shortening, water, eggs, milk such as nonfat dried milk, baking powder, salt, vanilla extract, or fruits such as blueberries.

In a specific embodiment, a gluten-free muffin of the invention may include the following ingredients: about 15 (e.g., 16) wt-% deflavored pinto bean flour, about 10 wt-% corn starch, about 15 (e.g., 16) wt-% sugar, about 10 wt-% shortening, about 20 (e.g., 18) wt-% water, about 15 (e.g., 13) wt-% egg, about 2 (e.g., 1.9) wt-% nonfat dried milk, about 1 (e.g., 1.3) wt-% baking powder, about 0.3 wt-% salt, about 0.4 wt-% vanilla extract, and about 15 (e.g., 13) wt-% drained blueberries.

Any suitable method known in the art may be used to produce a gluten-free muffin of the invention. In an embodiment, the sugar and shortening were first creamed. Pre-blended dries were added and mixed. Liquid ingredients were added in and mixed. Blueberries were added and mixed until evenly distributed. 50 g of batter was placed in a muffin pan and baked at 400° F. for 15-18 min to produce a muffin.

Pasta

In an embodiment, the present invention includes a gluten-free or low gluten pasta with good color, good texture, and/or good flavor. In an embodiment, the pasta is more functional e.g., it requires minimal rinsing and can be refrigerated and re-served. In an embodiment, the gluten-free pasta includes about 10 wt-% to about 60 wt-% deflavored bean powder by weight. In an embodiment, the gluten-free pasta includes about 10 wt-% to about 20 wt-%, about 16 wt-%, about 25 wt-%, or about 50 wt-% deflavored bean powder by weight. In an embodiment, the deflavored bean powder is deflavored navy bean powder.

During the development of a pasta of the invention, both deflavored pinto bean flour and deflavored navy bean flour were tested, and the resulting pasta product was assessed. Initially, deflavored pinto flour was used, but the pasta turned a pinkish color during cooking. At that point, the deflavored pinto flour was deleted and deflavored navy bean flour was substituted. The addition of the deflavored pinto bean flour or deflavored navy bean flour was found to reduce the stickiness observed when rice pasta was used. The best tasting product included a mixture of corn and navy bean flour.

Several different combinations of deflavored pinto bean powder and rice flour were also explored in the production of pasta using a Wenger extruder. Initially, about 15 wt-% deflavored pinto bean powder in rice flour was tested. The amount of deflavored pinto bean was then raised to about 25 wt-%. As the percentage of deflavored bean powder increased the size of the product became smaller. The percentage of deflavored bean powder was then increased to about 50 wt-%. It was discovered that a 50 wt-% deflavored bean powder in rice flour mixture provided an advantageous product that received a positive response from a panel of pasta taste testers.

In an embodiment, a gluten-free pasta of the invention can also include other ingredients known in the art. By way of nonlimiting example, a gluten-free pasta may include any combination of suitable amounts of flour, including, for example, a non-GMO corn flour such as Cargill 0505000S yellow corn flour.

In a specific embodiment, a gluten-free pasta of the invention may include the following ingredients: about 50 wt-% non-GMO corn flour, about 50 wt-% deflavored navy bean flour (powder), and 0.75 wt-% glycerol monostearate (Dimodan).

Any suitable method known in the art may be used to produce a gluten-free pasta of the invention. In an embodiment, Wenger TX-57 or TX-85 extruders, and a Wenger pasta dryer are used to provide an advantageous product. A test was run with a DeMaco extruder but without the pre-conditioner, but the taste and texture of the final product was not as desirable.

Cookie

In an embodiment, the present invention includes a gluten-free or low gluten cookie, such as a chocolate chip cookie, having good color, good texture, and/or good flavor. In an embodiment, the gluten-free cookie includes about 5 wt-% to about 60 wt-% deflavored bean powder by weight, and may include, for example, about 10 wt-% to about 30 wt-%, or about 20 wt-% deflavored bean powder by weight. In an embodiment, the deflavored bean powder is deflavored pinto bean powder.

In an embodiment, a gluten-free cookie of the invention can also include other ingredients known in the art. By way of nonlimiting example, a gluten-free cookie can include any combination of suitable amounts of sugar, brown sugar, margarine, eggs, soda, salt, vanilla extract, or flavorings such as chocolate chips.

In a specific embodiment, a gluten-free cookie of the invention may include the following ingredients: about 20 wt-% deflavored pinto bean flour, about 15 wt-% sugar, about 15 (e.g., 14) wt-% brown sugar, about 20 (e.g., 22) wt-% margarine, about 10 (e.g., 9.7) wt-% egg, about 0.4 wt-% soda, about 0.4 wt-% salt, about 0.4 wt-% vanilla extract, and about 20 wt-% chocolate chips.

Any suitable method known in the art may be used to produce a gluten-free cookie of the invention. In an embodiment, the sugar and shortening were first creamed. Liquid ingredients were added and mixed in. Pre-bended dries were added and mixed. Chocolate chips were added and mixed until evenly distributed. Dough was shaped into balls and placed on a greased cookie sheet then baked at 350° F. for 12-14 min.

Deflavored Vegetable Powder

In an embodiment, the deflavored vegetable powder is a powder disclosed in U.S. Pat. No. 7,097,871, issued Aug. 29, 2006 to Rudi et al., the content of which is hereby expressly incorporated in its entirety. The deflavored vegetable powder disclosed in U.S. Pat. No. 7,097,871 can be employed in the products described herein.

In an embodiment, the deflavored vegetable powder possesses a level of lipoxygenase activity that is less than 75 wt-%, 50 wt-%, or 1 wt-% of the levels possessed by the corresponding raw vegetable powder.

In an embodiment, the deflavored vegetable powder is produced from a millable vegetable that has been steam treated at a predetermined temperature for a predetermined time.

In an embodiment, the deflavored vegetable powder is produced from a millable vegetable that was milled at a sufficiently low temperature, for example, from about 10 to about 45° C., to avoid burnt flavors or unacceptable levels of protein denaturation.

In an embodiment, the vegetable powder used in the present invention, or a product containing or made from the vegetable powder, can have flavor rated better than the flavor of conventional vegetable powders and food products made from the conventional powders. Flavor can be evaluated by any of a variety of known methods. For example, the present vegetable powder or product made from it can be evaluated for flavor by a flavor panel according to a standard scale of flavor.

In an embodiment, flavor can be evaluated by producing an aqueous suspension or homogenate of the vegetable powder and ranking the flavor of the suspension or homogenate on a flavor scale. Such a scale can, for example, rank soybean (e.g., soy powder or soy milk) flavors from 1 to 10 with, for example, 1 being the lowest rank and indicating a rancid flavor; a rank of 2 indicating a painty flavor; a rank of 3 indicating a rancid and sour flavor; a rank of 4 indicating a soapy flavor; a rank of 5 indicating an obviously green and beany flavor, an unpleasant soy flavor; a rank of 6 indicating little beany flavor, flat soy flavor; a rank of 7 indicating a slightly beany flavor and little nutty flavor; a rank of 8 indicating good, nutty, clean soymilk flavor; a rank of 9 indicating a bland flavor; and 10 being the highest rank and indicating a fresh and pleasant flavor. A conventional vegetable powder can yield a suspension or homogenate with a flavor ranking below 5. A vegetable powder according to the present invention yields a suspension or homogenate with a flavor ranking of at least 7, at least 8, at least 8.5, or at least 9.

In an embodiment, flavor can be evaluated by producing a baked good made from the vegetable powder, and ranking the flavor of the baked good on a flavor scale. Such a scale can, for example, rank baked good flavors from 1 to 10 with, for example, 1 being the lowest rank and indicating a rancid flavor; a rank of 2 indicating a painty flavor; a rank of 3 indicating a rancid and sour flavor; a rank of 4 indicating a soapy flavor; a rank of 5 indicating an obviously green and beany flavor; a rank of 6 indicating little beany flavor, or flat flavor; a rank of 7 indicating a slightly beany flavor and little nutty flavor; a rank of 8 indicating good, nutty, flavor; a rank of 9 indicating a bland flavor; and 10 being the highest rank and indicating a fresh and pleasant flavor. A conventional baked good containing a vegetable powder can yield a flavor ranking below 5. A baked good containing vegetable powder according to the present invention yields a baked good product with a flavor ranking of at least 7, at least 8, at least 8.5, or at least 9.

In an embodiment, the deflavored vegetable powder or a food product made using the powder can have reduced off taste compared to conventional vegetable powders and food products made from the conventional powders. Off taste can be evaluated by any of a variety of known methods. For example, the deflavored vegetable powder or product made from it can be evaluated for off taste by a flavor panel according to a standard scale of off taste.

In an embodiment, off taste can be evaluated by producing an aqueous suspension or homogenate of the vegetable powder, or a baked good containing the vegetable powder, and ranking the off taste of the suspension, homogenate, or baked good on a scale. Such a scale can, for example, rank off tastes from 1 to 10 with 1 indicating the lowest amount of off taste, e.g., no rancid taste, and 10 indicating the highest amount of off taste, e.g., maximum rancidity. According to this scale, rank and off taste correspond as: 1, no rancid taste; 2, slightly bitter off taste; 3, slightly oxidized, slight cardboard, or somewhat green off taste; 4, slightly cooked off taste; 5, metallic off taste; 6, beany off taste; 8, soapy off taste; 9, painty off taste; and 10, very rancid off taste. A vegetable powder according to the present invention yields a suspension or homogenate with an off taste ranking of less than or equal to 4, less than or equal to 2, or less than or equal to 1.

Additional methods for comparing the taste of food products are known in the art. The portion of U.S. Pat. No. 6,899,905 relating to a method for rating the taste system of a food product is expressly incorporated by reference. In an embodiment, the food products of the present invention may have, for example, a lower taste value greater than −9.00 at a 60%, 70%, 80%, 90%, 95%, or 99% confidence level, when compared to a reference product, such as a corresponding gluten-containing food product, using the rating system disclosed in U.S. Pat. No. 6,899,905.

In an embodiment, the present invention includes a food product having about 10 wt-% to about 60 wt-% of a deflavored vegetable powder, such as a bean powder. In an embodiment and by way of nonlimiting example, the present invention includes a food product including a deflavored vegetable powder, such as deflavored bean powder, in the amount of about 5 wt-% to about 60 wt-%, about 10 wt-% to about 60 wt-%, about 25 wt-% to about 50 wt-%, about 30 wt-% to about 50 wt-%, about 10 wt-% to about 30 wt-%, about 5 wt-% to about 20 wt-% by weight, or about 10 wt-% to about 20 wt-% by weight.

The present invention may be better understood with reference to the following examples. These examples are intended to be representative of specific embodiments of the invention, and are not intended as limiting the scope of the invention.

### EXAMPLES

### Example 1

### Gluten Free Chocolate Chip Cookies or Gluten Free Blueberry Muffins Possess Flavor Advantages When Made from a Deflavored Pinto Bean Flour of the Present Invention

This example demonstrates that baked products have improved flavor characteristics when made from deflavored pinto bean flour instead of raw pinto bean flour.

Materials And Methods

Production of Raw and Steam Cooked (Deflavored) Pinto Bean flour.

Two thousand pounds of pinto beans were processed into steam cooked pinto bean flour by the following method. Pinto beans were steam treated at 120° C. for 4 min. They were then dried at 70° C. for approximately 3 hr to 5 wt-% moisture, followed by milling to a 300 mesh deflavored pinto bean flour.

Two thousand pounds of pinto beans were processed into raw pinto bean flour by the following method. Pinto beans were dried at 70° C. for approximately 3 hr to 12 wt-% moisture, and then milled to a 300 mesh raw pinto bean flour.

Production of Gluten Free Chocolate Chip Cookies from Pinto Bean Flour.

To determine the benefit of using deflavored pinto bean flour instead of raw pinto bean flour in production of cookies, chocolate chip cookies were made using either the deflavored or raw pinto bean flour for the present Example.

Cookies were made with 19.5 wt-% deflavored or raw pinto bean flour, 14.6 wt-% sugar, 13.6 wt-% brown sugar, 21.8 wt-% margarine, 9.7 wt-% egg, 0.4 wt-% soda, 0.4 wt-% salt, 0.4 wt-% vanilla extract, and 19.5 wt-% chocolate chips. The sugar and shortening were first creamed. Liquid ingredients were added in and mixed. Preblended dries were added and mixed. Chips were added and mixed until evenly distributed. Dough was shaped into balls and placed on a greased cookie sheet, and then baked at 350° F. for 12-14 min. Cookies were evaluated organoleptically by a 3 person panel for raw bean flavors and fishy oxidation notes.

Production of Gluten Free Muffins from Pinto Bean Flour.

To determine the benefit of using deflavored pinto bean flour instead of raw pinto bean flour in muffin production, muffins were made using either the deflavored or raw pinto bean flour of the present Example.

Muffins were made with 15.6 wt-% deflavored or raw pinto bean flour, 10.4 wt-% corn starch, 15.6 wt-% sugar, 10.4 wt-% shortening, 18.2 wt-% water, 13 wt-% egg, 1.9 wt-% nonfat dried milk, 1.3 wt-% baking powder, 0.3 wt-% salt, 0.4 wt-% vanilla extract, and 13 wt-% drained blueberries. The sugar and shortening were first creamed. Preblended dries were added and mixed. Liquid ingredients were added in and mixed. Blueberries were added and mixed until evenly distributed. 50 g of batter was placed in a muffin pan and baked at 400° F. for 15-18 min. Muffins were evaluated organoleptically by a 3 person panel for raw bean flavors and fishy oxidation notes.

Results

The results of the organoleptic evaluation of the cookies and muffins made from deflavored and raw pinto beans are shown in Table 1.

TABLE 1
Improved Flavor In Baked Goods Made With Deflavored Pinto Bean Flour

| | Raw Pinto Bean Flavor | Fishy Oxidation Flavor |
|---|---|---|
| Deflavored Pinto Bean | − | − |
| Cookies | | |
| Raw Pinto Bean | + | ++ |
| Cookies | | |
| Deflavored Pinto Bean | − | − |
| Muffins | | |
| Raw Pinto Bean | + | + |
| Muffins | | |

Flavors were evaluated on a 3 point scale:
negative (−);
distinctly noticeable (+); and
extremely noticeable (++).

Conclusions

The results shown in Table 1 demonstrate that the use of deflavored pinto bean flour instead of raw pinto bean flour is advantageous in the production of both gluten-free chocolate chip cookies and blueberry muffins, by reducing objectionable pinto bean flavors as well as the presence of fishy odors believed to result from lipid oxidation.

### Example 2

### The Present Invention Produces a Superior Gluten Free Pasta with Deflavored Navy Bean Powder

This example demonstrates that pasta products have improved flavor characteristics when made from deflavored navy bean flour instead of raw navy bean flour.

Materials and Methods

Deflavored, steam cooked, navy bean flour was produced according to Example 1. Pasta was made with 49.63 wt-% non-GMO corn flour, 49.63 wt-% navy bean flour, and 0.75 wt-% glycerol monostearate (Dimodan).

The pasta was manufactured using Wenger TX-57 or TX-85 extruders, with pre-conditioner. Pasta dies with 25/10000ths openings were used to give “quick-cook” results. The flour mixture was blended in a ribbon blender and transported to the pre-conditioner. The flour mixture was turned into a batter with the addition of steam and water, and pressed through the dies. The wet pasta was then sent through a dryer for 40 minutes at 70 degrees Centigrade, cooled and packaged.

Results

The responses of taste testers to the pasta was collected from a variety of sources, and were uniformly positive.

### Example 3

### Production of Gluten Free Pinto Bean Cereals of the Invention

This example demonstrates that cereal products have improved characteristics when made from deflavored pinto bean flour.

Materials and Methods

Deflavored, steam cooked, pinto bean flour was produced according to Example 1. Cereal containing either 15 wt-% or 25 wt-% pinto bean flour was produced using three different treatments. The ingredients and process parameters for each treatment are shown in Table 2. Briefly, dry ingredients were blended for 15 minutes using the V-blender, placed in the extruder feeder, and metered through the DDC preconditioner; however, the dry ingredients were not preconditioned prior to entering the TX-52 extruder. The treatments were processed on the TX-52 using a six head screw profile and a crisp rice die 74010-675 (Wenger Manufacturing). Water was injected into the barrel as needed to control the process and product quality. Product was collected on stainless steel trays, and dried in a Lincoln air impingement oven.

TABLE 2
Cereal Process Parameters

| | Treatment | | |
|---|---|---|---|
| | 1 | 2 | 3 |
| Formula | | | |
| Long Grain Rice Flour (RL-100) | 99.25 | 84.25 | 74.25 |
| (wt-%) | | | |
| Pinto Bean Powder (wt-%) | 0 | 15 | 25 |
| Glycerol Monostearate (Dimodan) | 0.75 | 0.75 | 0.75 |
| (wt-%) | | | |
| Process Variables | | | |
| Die Shape | Rice | Rice | Rice |
| Die Number | 74010- | 74010- | 74010- |
| | 675 | 675 | 675 |
| Extruder Setup | | | |
| Length to Diameter Ratio | 16.5:1 | 16.5:1 | 16.5:1 |
| Wenger Configuration Number | 641 | 641 | 641 |
| Preconditioning | No | No | No |
| Process Data | | | |
| Dry Recipe Rate, measured (kg/hr) | 67.1 | — | — |
| Dry Recipe Rate, estimate (kg/hr) | — | 67.1 | 67.1 |
| Feed Screw Speed (RPM) | 13 | 13 | 13 |
| Preconditioning Information | | | |
| Steam Flow to Preconditioner | 0 | 0 | 0 |
| Water Flow to Preconditioner | 0 | 0 | 0 |
| Conditioned Meal Temperature | As is | As is | As is |
| (° C.) | | | |
| Extrusion Information | | | |
| Extruder Shaft Speed (rpm) | 299 | 302 | 301 |
| Extruder Motor Load (wt-%) | 32 | 28 | 28 |
| Steam Flow to Extruder (kg/hr) | 0 | 0 | 0 |
| Water Flow to Extruder (kg/min) | 0.067 | 0.067 | 0.103 |
| Knife Drive Speed (wt-%) | 100 | 100 | 100 |
| Temp - 1st head (° C.) | Not Controlled or | | |
| | Measured | | |
| Temp - 2nd head (° C.) | 30 | 31 | 32 |
| Temp - 3rd head (° C.) | 43 | 44 | 45 |
| Temp - 4th head (° C.) | 85 | 85 | 85 |
| Temp - 5th head (° C.) | 85 | 85 | 85 |
| Temp - 6th head (° C.) | 98 | 97 | 96 |
| 5th Head Pressure (psi) | 0 | 0 | 0 |
| 6th Head Pressure (psi) | 1000 | 850 | 900 |

Results

It was discovered that the use of deflavored pinto bean powder worked well in the production of crisp rice product at both the 15 and 25 wt-% levels tested. The 25 wt-% pinto bean powder treatment, however, required additional moisture at the barrel, and had a slightly smaller shape compared to the rice control and the 15 wt-% pinto bean powder treatment. The 15 and 25 wt-% pinto bean powder products had a similar tan color, and good taste and mouth feel.

Conclusion

An excellent gluten-free cereal can be produced using a combination of deflavored pinto bean flour and rice flour.

### Example 4

### Production of Gluten-Free Bread from Deflavored Pinto Bean Flour

This example demonstrates that bread products have improved flavor characteristics when made from deflavored pinto bean flour instead of raw pinto bean flour.

Materials and Methods

Deflavored pinto bean flour was produced according to Example 1. Gluten-free bread was baked using pinto bean flour, rice flour, a combination of pinto bean flour and cellulose gums, or a combination of rice flour and cellulose gums. The ingredients of breads baked using each of the flour/flour combinations are shown in Table 3 and Table 4.

The dry ingredients were blended for 15 minutes using the V-blender, placed in the extruder feeder, and metered through the DDC preconditioner; however, the dry ingredients were not preconditioned prior to entering the TX-52 extruder. The treatments were processed on a TX-52 using a six head screw profile and a crisp rice die 74010-675 (Wenger

TABLE 3
Gluten-Free Bread Formulas in True Percent

| | True wt-% | | | |
|---|---|---|---|---|
| | | | pinto bean | rice flour |
| | pinto bean | | flour and | and cellulose |
| | flour | rice flour | cellulose gums | gums |
| Water | 33.8 | 29.1 | 33.6 | 29.2 |
| Eggs | 15.0 | 15.0 | 15.3 | 15.9 |
| Canola oil | 3.3 | 3.3 | 3.4 | 3.5 |
| Sugar | 3.1 | 3.1 | 1.5 | 1.5 |
| Rice flour | 12.2 | 29.1 | 12.4 | 27.7 |
| Bean flour | 12.2 | 0.0 | 12.4 | 0.0 |
| Potato starch | 8.6 | 8.6 | 8.8 | 9.2 |
| Tapioca flour | 4.9 | 4.9 | 5.0 | 5.2 |
| Xanthan gum | 0.7 | 0.7 | 0.8 | 0.8 |
| Benecel M043¹ | 0 | 0 | 0.3 | 0.3 |
| Blanose 7MXF² | 0 | 0 | 0.1 | 0.1 |
| Salt | 0.7 | 0.7 | 0.8 | 0.8 |
| Nonfat dry milk | 4.9 | 4.9 | 5.0 | 5.2 |
| Instant yeast | 0.6 | 0.6 | 0.6 | 0.6 |
| Total | 100.0 | 100.0 | 100.0 | 100.0 |

¹Methylcellulose (Nonionic cellulose ether), Hercules Incorporated
²Sodium carboxymethylcellulose (CMC), Hercules Incorporated

TABLE 4
Gluten-free Bread Formulas in Bakers Percent

| | Bakers wt-% | | | |
|---|---|---|---|---|
| | | | pinto bean | rice flour |
| | pinto bean | | flour and | and cellulose |
| | flour | rice flour | cellulose gums | gums |
| Water | 138.5 | 100.0 | 135.5 | 105.4 |
| Eggs | 61.5 | 51.5 | 61.7 | 57.4 |
| Canola oil | 13.5 | 11.3 | 13.7 | 12.6 |
| Sugar | 12.7 | 10.7 | 6.0 | 5.4 |
| Rice flour | 50.0 | 100.0 | 50.0 | 100.0 |
| Bean flour | 50.0 | 0.0 | 50.0 | 0.0 |
| Potato starch | 35.2 | 29.6 | 35.5 | 33.2 |
| Tapioca flour | 20.1 | 16.8 | 20.2 | 18.8 |
| Xanthan gum | 2.9 | 2.4 | 3.2 | 2.9 |
| Benecel M043 | 0 | 0 | 1.2 | 1.1 |
| Blanose 7MXF | 0 | 0 | 0.4 | 0.4 |
| Salt | 2.9 | 2.4 | 3.2 | 2.9 |
| Nonfat dry milk | 20.1 | 16.8 | 20.2 | 18.8 |
| Instant yeast | 2.5 | 2.1 | 2.4 | 2.2 |
| Total | 409.8 | 343.6 | 403.2 | 361.0 |

Manufacturing). Water was injected into the barrel as needed to control the process and product quality. Product was collected on stainless steel trays and dried in a Lincoln air impingement oven.

For purposes of comparison, a conventional gluten-free bread was baked using a commercially available bread mix (The Gluten-Free Pantry® Favorite Sandwich Bread Mix). This bread mix contains brown rice flour, rice flour, cornstarch, potato starch, powdered skim milk, whey, brown sugar, guar gum, salt, gluten-free yeast. Eggs, water, and oil were added according to the package directions in the amounts shown in Table 5.

TABLE 5
Gluten-free Bread Mix Formula in True Percent

| | wt-% |
|---|---|
| Water | 35.0 |
| Yeast | 0.6 |
| Eggs | 8.5 |
| Oil | 2.4 |
| Mix | 53.4 |
| Total | 100.0 |

Baking Procedure

All breads were baked according to the following procedure. All ingredients were at room temperature (about 72° F.). Water was heated in microwave to 110-115° F. Water was placed in a mixing bowl. Yeast was sprinkled on top and allowed to dissolve for 5 min. Dry ingredients were sifted into the pan and dough was blended at stir speed. Eggs and oil were added and blended at stir speed. The bowl was scraped down and dough was mixed for 5 min. at medium speed. Mixing was stopped and bowl was scraped down halfway through mixing. Dough was scraped into 2 well-greased loaf pans, 750 g in each. Tops were smoothed with a bread scraper and weight was checked. Dough was proofed 1 hour at 77° F., 70% RH. Bread with cellulose gums was baked 50 min. at 400° F. Bread without cellulose gums was baked 55 min. at 400° F. Bread was covered with aluminum foil after 20 min. of baking to prevent excessive browning. Bread was placed in plastic bags after 2 hours of cooling.

Analytical Procedure

The volume of the breads was taken the morning after baking using rapeseed displacement. Texture analysis was performed using a TAX-T2 texture analyzer and the AIB standard procedure for firmness of white pan bread crumb by compression with a probe. Two slices of bread (½ inch thick) were tested. Measurements were taken the day after baking (day 1) and 2 days later (day 3). The results of the tests are displayed in Table 6.

TABLE 6
Gluten-free Bread Volume and Texture Results

| | Volume | Day 1 texture | Day 3 texture |
|---|---|---|---|
| | (cc) | (g of force) | (g of force) |
| Gluten-free bread with | 1738 | 340.6 | 465.4 |
| deflavored pinto bean | | | |
| flour | | | |
| Gluten-free bread with | 1775 | 1041.7 | 1181.9 |
| rice flour | | | |
| Gluten-free bread with | 1663 | 802.5 | 1056.5 |
| deflavored pinto bean | | | |
| flour and cellulose gums | | | |
| Gluten-free bread with | 1700 | 1048.8 | 1270.9 |
| rice flour and cellulose | | | |
| gums | | | |
| Commercial gluten-free | 1663 | 1043.3 | 1081.4 |
| mix | | | |

As shown in Table 6, bread made with deflavored pinto bean flour substituted for part of the rice flour had volume equal to or better than the commercial mix. Bread made with deflavored pinto bean flour substituted for part of the rice flour had a softer crumb texture than bread made with rice flour alone or commercial mix. The addition of deflavored pinto bean flour resulted in a bread with crumb color more similar to whole wheat bread.

Nutritional Comparison of Deflavored Pinto Bean Flour and Rice Flours

An additional advantage of substituting deflavored pinto bean flour for rice or brown rice flour in the production of bread is the enhanced nutritional profile of the product compared to conventional gluten-free bread. The nutritional profile was determined for deflavored pinto bean flour and is shown in Table 7. Improvements depended on the level of pinto bean flour used.

TABLE 7
Comparison of Nutrients of Pinto Bean and Rice Flours

| | % | | |
|---|---|---|---|
| | deflavored | | |
| | pinto bean | rice flour, | rice flour, |
| | flour | white¹ | brown¹ |
| Moisture | 14.03 | 11.89 | 11.97 |
| Protein | 20.32 | 5.95 | 7.23 |
| Fat | 1.34 | 1.42 | 2.78 |
| Dietary fiber | 16.3 | 2.4 | 4.6 |
| Ash | 3.62 | 0.61 | 1.54 |
| Carbohydrates | 60.69 | 80.13 | 76.48 |

¹Values taken from the USDA National Nutrient Database for Standard Reference, Release 16 (July 2003)

Conclusions

Deflavored Pinto bean flour contained 14% more protein than rice flour, and 13% more than brown rice flour. The protein amino acid profile of deflavored pinto bean flour complements the amino acid profile of the rice flour to provide a “complete” protein. Deflavored pinto bean flour had 0.1% less fat than rice flour and 1% less than brown rice flour. Nutritionists recommend diets lower in fat. Furthermore, the amount of dietary fiber in the deflavored pinto bean flour was 14% higher than rice flour and 12% higher than brown rice flour. The consumption of dietary fiber has many health benefits, including reducing blood cholesterol and or blood glucose. Additionally, deflavored pinto bean flour ash content is 3% higher than rice flour and 2% higher than brown rice flour. Ash is the mineral residue that remains after complete oxidation of a sample. The deflavored pinto bean flour is a whole bean product, which accounts for the higher ash value. Carbohydrates were 19% lower in pinto bean flour compared to rice flour, and 16% lower than brown rice flour. Carbohydrate values include sugars, starches, celluloses, and gums. The advantages of using the cellulose gums are that dough can be proofed at a higher temperature, and the bread cooks slightly faster.

### Example 6

### Lipoxygenase Activity is Higher in Raw Pinto Bean Flour than in Deflavored Pinto Bean Flour

This Example demonstrates the superiority of steam treatment over roasting in reducing the level of lipoxygenase activity responsible for the fishy oxidation flavors noted in Example 1.

Materials and Methods

Deflavored pinto bean flour and raw pinto bean flour were obtained by the method of Example 1. Roasted pinto bean flour was generated by baking raw pinto bean flour at 120° C. for 0 to 120 min.

Lipoxygenase activity was determined by a known assay method. Briefly, pinto bean powders were homogenized in distilled water, then centrifuged for 20 min. at 1750×g. The supernatant was filtered through #2 Whatman filter paper. The lipoxygenase assay was conducted in 0.2 M phosphate buffer pH 9.0, at 30° C. using linoleic acid as substrate and methylene blue as a reporter. Lipoxygenase activity was followed as the decrease in optical density at 660 nm with time at 30° C. (OD/min) using a Beckman DU-7 spectrophotometer.

Results

Table 8 reports the relative lipoxygenase activity in the pinto bean flours.

TABLE 8
Pinto Bean Flour Lipoxygenase Activity

| | Relative Lipoxygenase |
|---|---|
| Sample | Activity (OD/min) |
| raw pinto flour | −0.841 |
| roasted pinto bean flour | −0.94 |
| (8 min) | |
| roasted pinto bean flour | −0.757 |
| (54 min) | |
| roasted pinto bean flour | −0.447 |
| (120 min) | |
| deflavored pinto bean | 0.0 |
| flour | |

Conclusions

Steam cooking of bean flour to produce deflavored bean flour is more effective than dry roasting in reducing lipoxygenase activity and controlling lipid oxidation.

### Example 7

### Production of Gluten-Free Muffins Using Deflavored Pinto Bean Flour

The objective was to evaluate a gluten-free muffin and determine the impact of pinto bean flour on mixing and baking.

Methods

The muffin formula used in this section was the “Quick and Easy Muffin Recipe”, from The Gluten-free Gourmet by Bette Hagman. It was tested with rice flour alone and with pinto bean flour substituted for part of the rice flour. The ingredients used to produce the muffins are as shown in Table 9 and Table 10.

TABLE 9
Quick & Easy Muffins with Rice Flour

| | Measure | | Grams | Unit | Grams | wt-% |
|---|---|---|---|---|---|---|
| Sugar | ¼ | Cup | 200 | Cup | 50.0 | 10.9 |
| Oil | 2 | Tbs | 13.6 | Tbs | 27.2 | 5.9 |
| Eggs | 2 | | 50 | | 100.0 | 21.7 |
| Rice flour | ⅔ | Cup | 158 | Cup | 105.9 | 23.0 |
| Tapioca flour | ⅙ | | 116 | Cup | 19.7 | 4.3 |
| Potato starch | ⅙ | | 140 | Cup | 23.8 | 5.2 |
| Salt | ¼ | Tsp | 6 | Tsp | 1.5 | 0.3 |
| Baking powder | 2 | Tsp | 4.6 | Tsp | 9.2 | 2.0 |
| Milk | ½ | Cup | 244 | Cup | 122.0 | 26.5 |
| Vanilla | ¼ | Tsp | 4.2 | Tsp | 1.1 | 0.2 |
| Total | | | | | 460.3 | 100.0 |

TABLE 10
Quick & Easy Muffins with Pinto Bean Flour

| | Measure | | Grams | Units | Grams | wt-% |
|---|---|---|---|---|---|---|
| Sugar | ¼ | Cup | 200 | Cup | 50.0 | 11.0 |
| Oil | 2 | Tbs | 13.6 | Tbs | 27.2 | 6.0 |
| Eggs | 2 | | 50 | | 100.0 | 22.1 |
| Rice flour | ⅓ | Cup | 158 | Cup | 52.1 | 11.5 |
| Bean flour | ⅓ | Cup | 140 | Cup | 46.2 | 10.2 |
| Tapioca flour | ⅙ | | 116 | Cup | 19.7 | 4.4 |
| Potato starch | ⅙ | | 140 | Cup | 23.8 | 5.3 |
| Salt | ¼ | Tsp | 6 | Tsp | 1.5 | 0.3 |
| Baking powder | 2 | Tsp | 4.6 | Tsp | 9.2 | 2.0 |
| Milk | ½ | Cup | 244 | Cup | 122.0 | 26.9 |
| Vanilla | ¼ | Tsp | 4.2 | Tsp | 1.1 | 0.2 |
| Total | | | | | 452.8 | 100.0 |

All ingredients were stored at room temperature (77° F.).

Procedure

Dry ingredients were mixed together in the mixing bowl. Liquid ingredients (oil, eggs, milk, and vanilla) were mixed together, added to the dry ingredients, and mixed at stir speed just until incorporated (Kitchen-Aid mixer). The resulting batter was poured into muffin tins (7 muffins) and baked 20 min at 350° F.

Results

Rice flour batter was very thin while bean flour batter was thick enough to scoop. Rice flour muffins were very pale colored, and slightly browned with a custard-like flavor while warm, but very chalky tasting and gritty after cooling. Bean flour muffins were the whole wheat-like color of a bran muffin. Bean flour muffins rose higher than rice flour muffins, and had very nicely cracked tops, good texture, and flavor.

### Example 8

### Production of a Precooked Rice Pasta and Precooked Rice Pasta Containing Pinto Bean Flour

The objective was to evaluate a gluten-free pasta and determine the impact of pinto bean flour on the product.

Processing Procedures

Deflavored Pinto Bean flour was produced according to Example 1. The ingredients and processing parameters for the production of the precooked pasta are as shown in Table 10. Briefly, the dry ingredients were blended for 15 minutes using the V-blender, and placed in the feeder above the preconditioner, which injected both steam and water. A moisture content of about 25 wt-% and a temperature of about 90° C. were achieved. Additional water and steam were injected into the barrel, and a vacuum applied. Product was extruded through a standard spaghetti die, collected onto rods, and stored at high relative humidity until it could be dried. The product was dried using a low temperature pasta profile (18-hour drying cycle).

TABLE 10
Precooked Pasta - Data Summary

| | Treatment | | | | | |
|---|---|---|---|---|---|---|
| Process Variables | 1 | 2 | 3 | 4 | 5 | 6 |
| Formula | | | | | | |
| Long Grain Rice Flour RL-100 | 99.25 | 74.44 | 49.63 | 0.00 | 0.00 | − |
| (wt-%) | | | | | | |
| Corn Flour (wt-%) | 0.00 | 0.00 | 0.00 | 99.25 | 49.63 | − |
| Pinto Bean Powder (wt-%) | 0.00 | 24.81 | 49.63 | 0.00 | 49.63 | − |
| Glycerol Monostearate | 0.75 | 0.75 | 0.75 | 0.75 | 0.75 | − |
| (Dimodan) (wt-%) | | | | | | |
| Process Variables | | | | | | |
| Die Shape | Spaghetti | Spaghetti | Spaghetti | Spaghetti | Spaghetti | − |
| Die Number | 41757 | 41757 | 41757 | 41757 | 41757 | − |
| Die Opening Diameter (inches) | 0.073 | 0.073 | 0.073 | 0.073 | 0.073 | − |
| Die Openings/Insert | 12 | 12 | 12 | 12 | 12 | − |
| Inserts Used | 16 | 16 | 16 | 16 | 16 | − |
| Process Data | | | | | | |
| Feed Screw Speed (RPM) | 14 | 15 | 14 | 14 | 13 | − |
| Preconditioning | | | | | | |
| Steam Flow Valve Setting | ¼ | ¼ | ¼ | ¼ | ¼ | − |
| (Turns) | | | | | | |
| Steam Ports Used (1-8) | 3 | 3 | 3 | 3 | 3 | − |
| Water Flow to Preconditioner | 0.19 | 0.19 | 0.19 | 0.16 | 0.112 | − |
| (kg/min) | | | | | | |
| Temp. Exiting Preconditioner | 92 | 91 | 93 | 93 | 93 | − |
| (° C.) | | | | | | |
| Extrusion | | | | | | |
| Extruder Shaft Speed (rpm) | 158 | 158 | 158 | 158 | 157 | − |
| Extruder Motor Load (%) | 28 | 34 | 26 | 27 | 24 | − |
| Steam Flow Valve Setting | ¼ | ¼ | ¼ | ¼ | ¼ | − |
| (Turns) | | | | | | |
| Steam Ports Used (1-8) | 4 | 4 | 4 | 4 | 4 | − |
| Water Flow to Extruder (kg/min) | 0.185 | 0.147 | N/A | N/A | 0.15 | − |
| Temp - 1st head (C.) | Not controlled or measured | | | | | |
| Temp - 2nd head (C.) | 89 | 92 | 93 | 93 | 95 | − |
| Temp - 3rd head (C.) | 110 | 110 | 110 | 110 | 110 | − |
| Temp - 4th head (C.) | 110 | 110 | 110 | 110 | 110 | − |
| Temp - 5th head (C.) | 110 | 110 | 110 | 110 | 110 | − |
| Temp - 6th head (C.) | 110 | 110 | 110 | 110 | 110 | − |
| Temp - 7th head (C.) | 91 | 94 | 91 | 87 | 90 | − |
| Temp - 8th head (C.) | 97 | 95 | 95 | 94 | 95 | − |
| Temp - 9th head (C.) | 97 | 95 | 95 | 94 | 95 | − |
| Pressure at Head 8 (psi) | 400 | 500 | 400 | 500 | 600 | − |
| Pressure at Head 9 (psi) | 600 | 750 | 650 | 800 | 800 | − |
| Formula | | | | | | |
| Long Grain Rice Flour RL-100 | 99.25 | 74.44 | 49.63 | 0.00 | 0.00 | − |
| (wt-%) | | | | | | |
| Corn Flour (wt-%) | 0.00 | 0.00 | 0.00 | 99.25 | 49.63 | − |
| Pinto Bean Powder (wt-%) | 0.00 | 24.81 | 49.63 | 0.00 | 49.63 | − |
| Glycerol Monostearate | 0.75 | 0.75 | 0.75 | 0.75 | 0.75 | − |
| (Dimodan) (wt-%) | | | | | | |
| Conventional Durum Semolina | − | − | − | − | − | + |
| Spaghetti | | | | | | |
| Cooked to Optimum | | | | | | |
| Diameter - uncooked (mm) | 1.8 | 1.85 | 1.71 | 1.87 | 1.63 | 1.65 |
| Optimum Cook Time (min) | 10 | 12 | 10 | 14 | 10 | 11 |
| Cooked Weight (g) | 63.7 | 63.4 | 60.8 | 64.1 | 54.4 | 75.6 |
| Cooking Loss (%) | 6.98 | 5.34 | 13.18 | 4.82 | 20.44 | 5.66 |
| Pasta Firmness (g * cm) | | | | | | |
| Rep 1 (g * cm) | 10.6 | 12.7 | 7.2 | 12.1 | 4.7 | 7.9 |
| Rep 2 (g * cm) | 14.5 | 13.9 | 7.3 | 11.5 | 4.8 | 8.1 |
| Average (g * cm) | 12.5 | 13.3 | 7.2 | 11.8 | 4.7 | 8 |
| Cooked to Optimum Plus 6.0 | | | | | | |
| Minutes | | | | | | |
| Cook Time (min) | 16 | 18 | 16 | 20 | 16 | 17 |
| Cooked Weight (g) | 66 | 67.9 | 66.1 | 67.3 | 56.6 | 78.7 |
| Cooking Loss (%) | 6.6 | 5.88 | 14.46 | 5.86 | 25.68 | 6.48 |
| Pasta Firmness (g * cm) | | | | | | |
| Rep 1 (g * cm) | 9.1 | 9.9 | 5.5 | 9.9 | 3.3 | 7.2 |
| Rep 2 (g * cm) | 9.3 | 9.9 | 5.7 | 10 | 3.3 | 7.1 |
| Average (g * cm) | 9.2 | 9.9 | 5.6 | 9.9 | 3.3 | 7.2 |

N/A = Data not available
Note:
All values are averages of two repetitions

Observations

Pinto bean flour seemed to work well in the precooked pasta. The addition of pinto bean flour to the rice flour seemed to make it less sticky.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

All publications and patent applications in this specification are indicative of the level of ordinary skill in the art to which this invention pertains.

The invention has been described with reference to various specific and preferred embodiments and techniques. However, it should be understood that many variations and modifications may be made while remaining within the spirit and scope of the invention.

What is claimed is:

1. A food product comprising deflavored bean powder.

2. The food product of claim 1, comprising about 5 wt-% to about 60 wt-% deflavored bean powder.

3. The food product of claim 2, wherein the food product is pasta.

4. The pasta of claim 3, comprising about 40 wt-% to about 60 wt-% deflavored bean powder.

5. The pasta of claim 4, wherein the deflavored bean powder comprises deflavored navy bean powder.

6. The food product of claim 2, wherein the food product is cereal.

7. The cereal of claim 6, comprising about 30 wt-% to about 50 wt-% deflavored bean powder.

8. The cereal of claim 7, wherein the deflavored bean powder comprises deflavored pinto bean powder.

9. The food product of claim 2, wherein the food product is a cookie.

10. The cookie of claim 9, comprising about 10 wt-% to about 30 wt-% deflavored bean powder.

11. The cookie of claim 9, wherein the deflavored bean powder comprises deflavored pinto bean powder.

12. The food product of claim 2, wherein the food product is a muffin.

13. The muffin of claim 12, comprising about 10 wt-% to about 20 wt-% deflavored bean powder.

14. The muffin of claim 12, wherein the deflavored bean powder comprises deflavored pinto bean powder.

17. The food product of claim 2, wherein the food product is bread.

18. The bread of claim 17, comprising about 5 wt-% to about 20 wt-% deflavored bean powder.

19. The bread of claim 17, wherein the deflavored bean powder comprises deflavored pinto bean powder.

20. The food product of claim 1, wherein an aqueous homogenate of the deflavored bean powder has a flavor rank of at least about 7, indicating flavor of slightly beany flavor and little nutty flavor;
wherein the flavor rank is based on a flavor scale on which 1 is the lowest rank and indicates green beany flavor, and 10 is the highest rank and indicates fresh and pleasant flavor.

21. The food product of claim 1, wherein an aqueous homogenate of the deflavored bean powder has an off taste rank of less than or equal to about 3, indicating off taste of slightly oxidized, slight cardboard, or somewhat green off taste;
wherein the off taste rank is based on an off taste scale on which 1 indicates the lowest amount of off taste and no rancid taste, and 10 indicates the highest amount of off taste and maximum rancidity.

21. The food product of claim 1, wherein the food product is free of gluten.

22. A food product comprising deflavored navy bean powder or deflavored pinto bean powder.

23. A food product comprising deflavored bean powder produced from raw bean powder, wherein the deflavored bean powder possesses less than 75% of the lipoxygenase activity of the raw bean powder.

24. A food product comprising deflavored bean powder, wherein the deflavored bean powder is produced from a milled vegetable that was not exposed to a temperature above 40° C. during milling.

25. A food product comprising deflavored bean powder, wherein the deflavored bean powder is produced by a process comprising the steps of contacting millable vegetable with steam at about 95° C. to about 130° C. for about 3 to about 12 min;
milling a millable vegetable, milling comprising:
contacting the vegetable with air previously passed through a cooling apparatus during milling,
contacting the vegetable with air previously passed through a drying apparatus during milling, or
contacting the vegetable during milling with air previously passed through a cooling apparatus and a drying apparatus;
simultaneously with milling, classifying the milled vegetable, classifying comprising:
contacting the vegetable with air previously passed through a cooling apparatus during classifying,
contacting the vegetable with air from a drying apparatus during classifying, or
contacting the vegetable during classifying with air previously passed through a cooling apparatus and a drying apparatus; and
producing vegetable powder of which 70% has a particle size less than 20 microns.
